(19) United States
(12) Patent Application Publication
(10) Pub. No.: US 2025/0245180 A1
(43) Pub. Date: Jul. 31, 2025

(54) SYSTEM AND METHOD FOR RESTORING OR TRANSFERRING OPERATIONAL PARAMETERS TO A COMPONENT OF A MODULAR AUTOMATION DEVICE

(71) Applicant: WAGO Verwaltungsgesellschaft mbH, Minden (DE)

(72) Inventors: Daniel JEROLM, Bad Essen (DE); Jonathan JANSEN, Porta Westfalica (DE); Anton LISCHEWSKI, Halle (Westf.) (DE); Andreas KRAATZ, Luhden (DE); Jan-Philipp JANSEN, Hille (DE); Timo Manuel HOLZKAMP, Extertal (DE); Torsten BERGER, Pr. Oldendorf (DE); Waldemar LEHMANN, Loehne (DE)

(73) Assignee: WAGO Verwaltungsgesellschaft mbH, Minden (DE)

(21) Appl. No.: 19/040,801

(22) Filed: Jan. 29, 2025

(30) Foreign Application Priority Data
Jan. 29, 2024 (DE) 10 2024 102 493.3

(51) Int. Cl. G06F 13/36

(52) U.S. Cl. CPC G06F 13/36; G06F 2213/40

(57) ABSTRACT

A system and a method for restoring or transferring operational parameters to a first component of a modular automation device. The method comprises dividing the operational parameters into a first parameter set, which enables the first component to communicate with a server that is accessible via a network connection of the automation device, and a second parameter set, storing the first parameter set on one or more second components of the modular automation device, and storing the second parameter set on the server.

This nonprovisional application claims priority under 35 U.S.C. § 119(a) to German Patent Application No. 10 2024 102 493.3, which was filed in Germany on Jan. 29, 2024, and which is herein incorporated by reference.

### BACKGROUND OF THE INVENTION

### Field of the Invention

The present invention relates to a system and a method for restoring or transferring operational parameters to a component of a modular automation device.

### Description of the Background Art

Automation components may be adapted for use in a specific environment as part of a configuration. If a component fails, it may be repaired or replaced with a new, identical component. In both cases, it may be necessary to adapt the component again for use in the specific environment.

### SUMMARY OF THE INVENTION

It is therefore an object of the invention to provide a system and method to restore or transfer operational parameters to a first component of a modular automation device that comprises dividing the operational parameters into a first parameter set, which enables the first component to communicate with a server that is accessible via a network connection of the automation device, and a second parameter set, storing the first parameter set on one or more second components of the modular automation device and storing the second parameter set on the server.

In this regard, the term “operational parameter”, can be understood, in particular, as referring to parameters without which the first component cannot fulfill its intended role as part of the modular automation device (or at best only to a very limited extent). Furthermore, the formulation that the first parameter set “enables the first component to communicate with a server which is accessible via a network connection of the automation device”, can be understood, in particular, to mean that the first parameter set is required to establish the network connection. For example, the first parameter set may be required to establish a connection between the component and a dedicated communication component of the modular automation device if the communication component is already connected to the server (or can establish a connection to the server if required) and can forward messages or user data from the first component to the server and from the server to the first component.

The term “server”, can be understood, in particular, as referring to an electronic network component which provides data and/or services for a plurality of modular automation devices, which may be retrieved or requested by the modular automation devices or the components of the modular automation devices. Furthermore, the term “component” can be understood, in particular, as referring to an electronic device: which comprises a processor, a memory (in which instructions executable by the processor are stored) and, potentially, sensors and/or actuators; which is configured to connect sensors or actuators; or which is configured to establish a connection with sensors and actuators. The first component may, for example, be an input/output module (I/O module) or a head module of a modular automation device which may be a modular fieldbus node that comprises the head module and several I/O modules connected to the head module.

In this context, the term “head module”, can refer to a component of a modular fieldbus node whose task it is to make the data and/or services of the I/O modules, which are connected to the head module, available via a fieldbus to which the head module is connected. Furthermore, the term “I/O module”, can be understood, in particular, as referring to an apparatus which is serially connectible or serially connected during operation to a head module and which connects one or more field devices to the head module and, if necessary (via the head module) to a higher-level control unit.

An I/O module may have one or more inputs and/or outputs configured for connecting field devices that provide state signals or process control signals. In this regard, the term “field devices”, can be understood, in particular, as referring to sensors and/or actuators which are connected (in terms of signaling) to the I/O module (e.g., electrically connected to the I/O module). Furthermore, the terms “input” and “output” can be understood, in particular, as referring to electric terminals such as, for example, connecting clamps.

If a field device is connected to an I/O module, it may be necessary to configure the I/O module to operate the field device. The I/O module may be configured by transferring the operational parameters to the I/O module. By configuring the I/O module, it may, for example, be determined which data is to be derived from signals received at the inputs of the I/O module and transmitted to a head module. Furthermore, by configuring the I/O module it may be determined which signals are to be derived from data received from the head module and, potentially, output at the outputs of the I/O module. In addition, after an initial configuration, it may be necessary to change or update the operational parameters stored on the I/O module, for example if the assigned tasks and/or the environment of the I/O module change, or a defective I/O module needs to be replaced.

If a head module is put into operation or (another) I/O module is connected to the head module, it may be necessary to configure the head module (to operate the I/O module). By configuring the head module, it may, for example, be specified how the head module is to communicate with a higher-level control unit and whether (or which) data of the I/O module is to be processed by the head module or forwarded to the higher-level control unit. Furthermore, configuring the head module may specify whether (or which) data from the higher-level control unit is to be processed by the head module or forwarded to the I/O module. In addition, after an initial configuration, it may be necessary to change or update the operational parameters stored on the head module if, for example, the assigned tasks and/or the environment of the head module change, or a defective head module needs to be replaced.

The term “second parameter set”, can be understood, in particular, as referring to a data set that specifies how process images are to be generated (for example how data is to be derived from signals received at the inputs of the I/O module and how said data is to be transmitted, e.g., via a bus, to the head module or from the head module to the higher-level control unit) and/or which data is to be forwarded from the higher-level control unit to the I/O module or how signals are to be derived from data transmitted from the head module to the I/O module (which are output, for example, at the outputs of the I/O module).

The first parameter set may be stored in at least partially redundant form on a plurality of second components of the modular automation device.

For example, the first parameter set may be stored in at least partially redundant form on a plurality of I/O modules of a modular fieldbus node. In particular, two identical copies of the first parameter set may be stored on two different I/O modules so that a failure or replacement of one of the I/O modules does not affect the availability of the first parameter set within the modular fieldbus node.

The plurality of second components of the modular automation device may transfer the first parameter set to the first component when the first component is integrated into the automation device for the first time or after a reset of the first component.

For example, the first component may identify itself when it is integrated into the automation device and the second components may deduce from the information sent during the identification that the first parameter set is intended for the first component and transfer the first parameter set to the first component.

The method may further comprise establishing a connection with the server and requesting the second parameter set by the first component, wherein the server transfers the second parameter set to the first component only if the server receives a message with an acknowledgment from an authorized device or via an authorized communication channel.

In particular, access to the second parameter set may be protected by two-factor authentication. For example, the first component may store a password (which may, for example, be a part of the first parameter set) and the server may deny access to the second parameter set despite the transmission of the password as long as the first component is not (yet) registered and the registration is not confirmed by an authorized device or via an authorized communication channel.

The server may notify the authorized device or via the authorized communication channel, of the second parameter set being requested by the first component and seek the confirmation.

For example, when the first component logs on to the server using the password, the server may send a message to the authorized device or via the authorized communication channel requesting confirmation that the first component is authorized and, upon confirmation, register the first component as authorized.

A system according to the invention comprises a modular automation device with a first component and one or more second components and a server, wherein the one or more second components are configured to store a first parameter set, wherein the server is configured to store a second parameter set, wherein the first parameter set enables the first component to request the second parameter set from the server via a network connection of the modular automation device, and wherein the second parameter set enables the first component to assume a predetermined role within the automation device.

The one or more second components can be configured to store the first parameter set in at least partially redundant form on a plurality of the second components of the modular automation device.

The plurality of second components of the modular automation device transfer the first parameter set to the first component when the first component is integrated into the automation device for the first time or after a reset of the first component.

The server may be configured to transfer the second parameter set to the first component, in response to the first component requesting it, only if the server receives a confirmation from an authorized device or via an authorized communication channel.

The server may be further configured to notify the authorized device or via the authorized communication channel, of the second parameter set being requested by the first component and to seek the confirmation.

Notably, all features described in connection with the system may also be features of the method and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of a fieldbus system;

FIG. 2 shows a schematic illustration of a fieldbus node and fieldbus devices connected to the fieldbus node;

FIG. 3 illustrates a storage of operational parameters of a first component of the fieldbus node on a second component of the fieldbus node and a server;

FIG. 4 illustrates a request for a transfer of a parameter set from the server to the first component of the fieldbus node;

FIG. 5 illustrates an authorization of a transfer of the parameter set from the server to the first component of the fieldbus node using two-factor authentication; and

FIG. 6 shows a flow chart of a method for restoring or transferring operational parameters to a component of a modular automation device.

### DETAILED DESCRIPTION

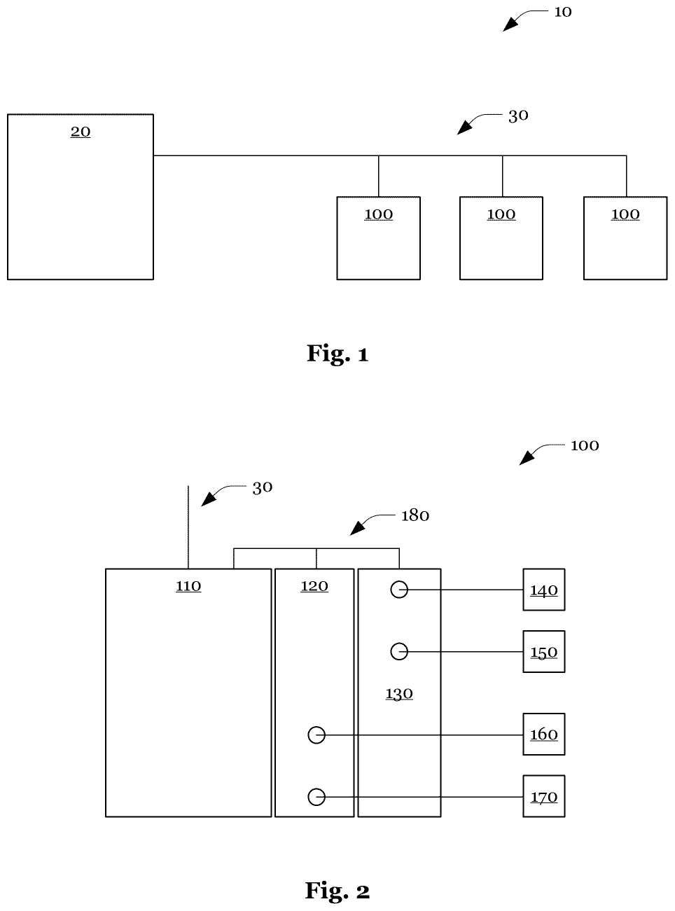

FIG. 1 shows a block diagram of a fieldbus system 10. The fieldbus system 10 comprises a higher-level control unit 20 to which a plurality of fieldbus nodes 100 are connected via a fieldbus 30. The higher-level control unit 20 may be used both, for monitoring and for controlling, an installation that is controlled by the fieldbus system 10. If the higher-level control unit 20 monitors an installation, the higher-level control unit 20 may cyclically or acyclically receive state data describing the state of the installation from the fieldbus nodes 100 and generate an alarm signal if the state of the installation deviates (substantially) from a desired/permitted state or state range. If the higher-level control unit 20 (not only monitors but also) controls the installation, the higher-level control unit 20 may cyclically or acyclically receive state data from the fieldbus nodes 100 and, taking the state data into account, determine control data that is transmitted to the fieldbus nodes 100.

FIG. 2 shows an exemplary modular fieldbus node 100, comprising a head module 110 and two I/O modules 120 and 130 which are serially connected to the head module 110. FIG. 2 further shows field devices 140, 150, 160 and 170, such as sensors and actuators, which are connected to the I/O modules 120 and 130. During operation, the I/O modules 120 and 130 read sensor signals through the inputs and generate state data from the sensor signals, which are transmitted to the head module 110 via the local bus 180. The head module 110 may process the state data locally and/or forward it (potentially in modified form) to the higher-level control unit 20. The higher-level control unit 20 (or head module 110 in the case of local processing) may then generate, taking the state data into account, control data.

The control data generated by the higher-level control unit 20 may then be transmitted to the (same or another) head module 110 via the field bus 30. The control data transmitted to the head module 110 (or generated by head module 110) is then forwarded/transmitted (potentially in modified form) to the I/O modules 120 and 130. The I/O modules 120 and 130 receive the control data and output control signals corresponding to the control data at the outputs to which the actuators are connected. The communication of data between the components of the fieldbus system 10 and the mapping of the sensor signals to state data and the mapping of the control data to control signals may be adapted to different application scenarios by configuring the fieldbus nodes 100. The configuration is carried out by transferring the corresponding parameters to the components of the fieldbus node 100.

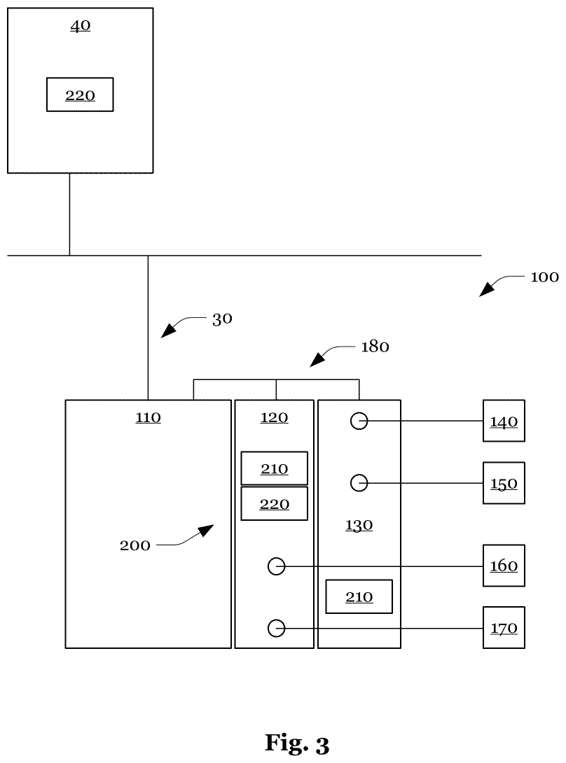

As shown in FIG. 3, the parameters 200, which result in a complete configuration of the I/O module 120, are divided into two parameter sets 210 and 220. Parameter set 210, which enables the I/O module 120 to communicate with the server 40 and is stored in the I/O module 130, and parameter set 220, which is stored on the server 40. For example, after completion of the configuration, the I/O module 120 may transfer the parameter set 210 to the I/O module 120 and transfer the parameter set 220 to the server 40. Furthermore, the parameter set 210 may also be stored in the head module 110 or, if available, other I/O modules to ensure local availability of the parameter set 210 even in the event of a failure of the I/O module 130.

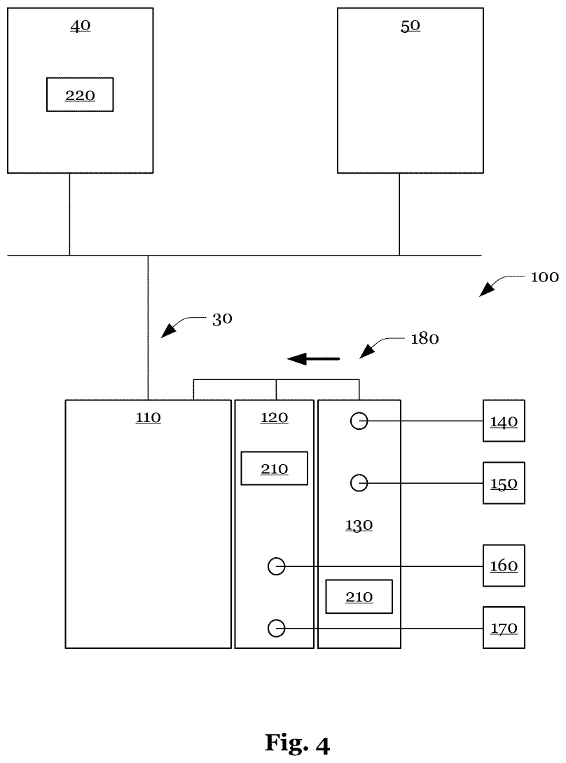

If the I/O module 120 is replaced with the identical I/O module 120 due to a defect, the latter obtains the parameter set 210, which enables the I/O module 120 to communicate with the server 40, by making the parameter set 210 available through the I/O module 130, as illustrated by the arrow in FIG. 4. If the parameter set 210 has been transferred from the I/O module 130 to the I/O module 120, the I/O module 120, using the parameter set 210, establishes a connection to the server 40 and requests the parameter set 220 from the server 40. It may be sufficient that the parameter set 210 enables the I/O module 120 to communicate with the head module 110 if the head module 110 is (independently) able to establish a connection to the server 40.

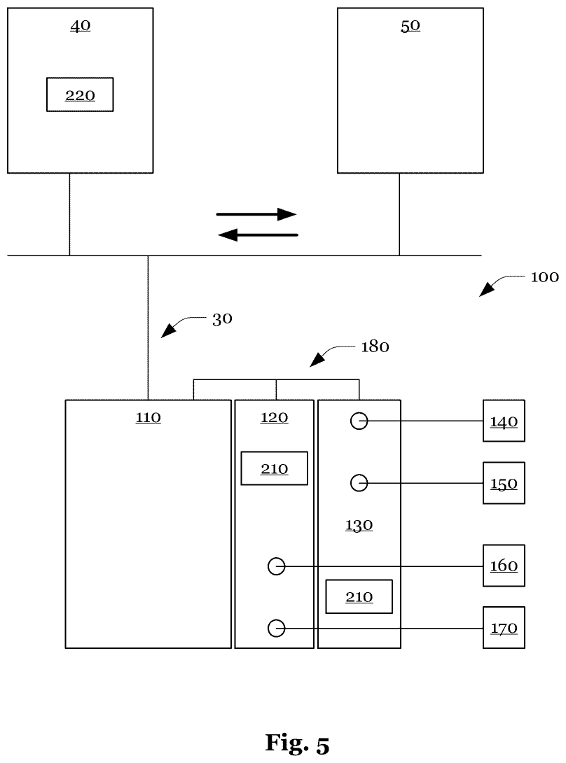

In order to protect the parameter set 220 from unauthorized access, the server 40 responds to the request by requesting authorization for the transmission from an authorized device 50, as indicated by the arrow in FIG. 5. If authorization is granted, the server 40 registers the I/O module 120 and transfers the parameter set 220 to the I/O module 120. By storing the parameter set 220, the configuration of the I/O module 120 is completed and the I/O module 120 is now fully operational. Instead of requesting authorization for the transmission from an authorized device 50, the permission may also be granted via an authorized communication channel, e.g., by means of (encrypted) email, SMS, push notification via app, etc.

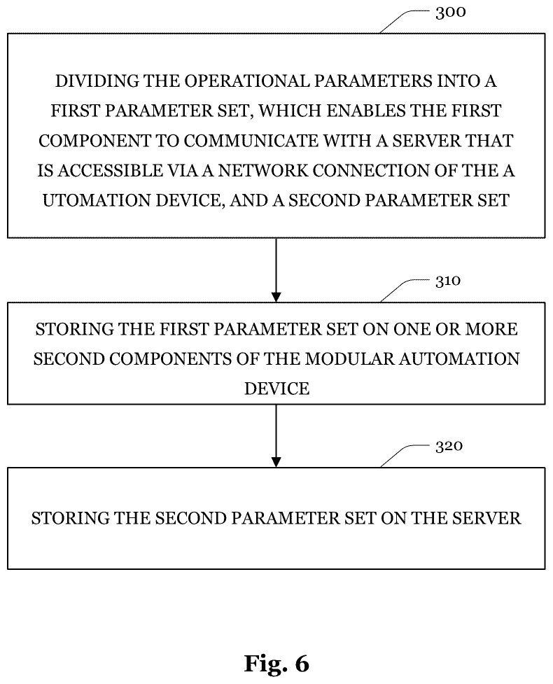

As shown in FIG. 6, the method for restoring or transferring operational parameters 200 comprises a step 300 of dividing the operational parameters 200 into a first set of parameters 210 which enables the I/O module 120 to communicate with the server 40 and a second set of parameters 220 which enables the I/O module 120 to assume a predetermined role. In step 310, the method continues with storing the first parameter set 210 on the I/O module 130. The method ends at step 320 with storing of the second parameter set 220 on the server 40.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for restoring or transferring operational parameters to a first component of a modular automation device, the method comprising:
dividing the operational parameters into a first parameter set, which enables the first component to communicate with a server that is accessible via a network connection of the automation device, and a second parameter set;
storing the first parameter set on one or more second components of the modular automation device; and
storing the second parameter set on the server.

2. The method of claim 1, wherein the first parameter set is stored in at least partially redundant form on a plurality of second components of the modular automation device.

3. The method of claim 2, wherein the plurality of second components of the modular automation device transfer the first parameter set to the first component when the first component is integrated into the automation device for the first time or after a reset of the first component.

4. The method of claim 1, further comprising:
establishing a connection with the server; and
requesting the second parameter set by the first component,
wherein the server transfers the second parameter set to the first component only if the server receives a message with an acknowledgment from an authorized device or via an authorized communication channel.

5. The method of claim 4, wherein the server notifies the authorized device or via the authorized communication channel, of the second parameter set being requested by the first component and seeks the confirmation.

6. A system comprising:
a modular automation device with a first component and one or more second components; and
a server,
wherein the one or more second components are configured to store a first parameter set,
wherein the server is configured to store a second parameter set,
wherein the first parameter set enables the first component to request the second parameter set from the server via a network connection of the modular automation device, and
wherein the second parameter set enables the first component to assume a predetermined role within the automation device.

7. The system of claim 6, wherein the one or more second components are configured to store the first parameter set in at least partially redundant form on a plurality of the second components of the modular automation device.

8. The system of claim 7, wherein the plurality of second components of the modular automation device transfer the first parameter set to the first component when the first component is integrated into the automation device for the first time or after a reset of the first component.

9. The system of claim 7, wherein the server is configured to transfer the second parameter set to the first component, in response to the first component requesting it, only if the server receives a confirmation from an authorized device or via an authorized communication channel.

10. The system of claim 9, wherein the server is further configured to notify the authorized device or via the authorized communication channel, of the second parameter set being requested by the first component and to seek the confirmation.
